(19) United States
(12) Patent Application Publication
(10) Pub. No.: US 2007/0115234 A1
(43) Pub. Date: May 24, 2007

(54) Display apparatus

(75) Inventors: Hee-Seop Kim, Gyeonggi-do (KR); Chang-Hun Lee, Gyeonggi-do (KR); Jun-Woo Lee, Gyeonggi-do (KR); Jian-Gang Lu, Gyeonggi-do (KR); Eun-Hee Han, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/543,544

(22) Filed: Oct. 4, 2006

(30) Foreign Application Priority Data
Nov. 22, 2005 (KR) 2005-111951

(51) Int. Cl. G09G 3/36

(52) U.S. Cl. 345/90

(57) ABSTRACT

In a display apparatus, a first display substrate includes a common electrode to which a common voltage is applied. A second display substrate facing the first display substrate includes a first pixel electrode and a second pixel electrode. The first and second pixel electrodes formed in one pixel region are spaced apart from and insulated from each other. A first data voltage having a first polarity with reference to the common voltage is applied to the first pixel electrode, and a second data voltage having a second polarity different from the first polarity with reference to the common voltage is applied to the second pixel electrode. Thus, a fringe field is formed between the first and second display substrates and a lateral field is formed in the second display substrate, thereby improving a transmittance and a response speed of the display apparatus.

### CROSS-REFERENCE TO RELATED APPLICATION

This application relies for priority upon Korean Patent Application No. 2005-111951filed on Nov. 22, 2005, the contents of which are herein incorporated by reference in its entirety.

### FIELD OF THE INVENTION

The present invention relates to a display apparatus, and more particularly relates to a liquid crystal display.

### DESCRIPTION OF THE RELATED ART

In general, a liquid crystal display includes an array substrate, a color filter substrate and a liquid crystal layer. The color filter substrate includes a common electrode to which a common voltage is applied, and the array substrate includes a pixel electrode to which a pixel voltage having a different voltage level from that of the common voltage is applied. Thus, a fringe field is formed between the array substrate and the color filter substrate due to a voltage difference between the common voltage and the pixel voltage, thereby rotating liquid crystal molecules of the liquid crystal layer.

The liquid crystal molecules have a rotation rate that is varied in accordance with the intensity of the fringe field formed between the array substrate and the color filter substrate. That is, when the intensity of the fringe field is enhanced, the rotation rate of the liquid crystal molecules increases, to thereby improve a transmittance and a response speed of the liquid crystal display.

However, since a conventional liquid crystal display has a configuration that one pixel electrode is formed in one pixel region, the fringe field is formed only between the array substrate and the color filter substrate. As a result, the conventional liquid crystal display cannot improve the transmittance and the response speed anymore.

### SUMMARY OF THE INVENTION

The present invention provides a display apparatus having an improved transmittance, an improved response speed and a reduced flicker. In one aspect of the present invention, a display apparatus includes a common electrode on one substrate and, on a facing substrate separated from the first substrate by a liquid crystal layer, first and second pixel electrodes electrically insulated from each other which receive data voltages of opposite polarity with reference to the common electrode voltage. The pixel electrodes are spaced apart from each other and with respect to the common electrodes so that a fringe field is formed between the first and second display substrates and a lateral field is formed in the second display substrate, thereby improving the transmittance and response speed. The first fringe field, caused by rotation of the liquid crystal molecules in response to the voltage difference between the first data voltage and the common voltage is formed between the first pixel electrode and the common electrode and a second fringe field, caused by rotation of the liquid crystal molecules in response to the voltage difference between a second data voltage and the common voltage, is formed between the second pixel electrode and the common electrode. Further, a lateral field, caused by rotation of the liquid crystal molecules in response to the voltage difference between the first and second data voltages, is formed between the first and second pixel electrodes. The lateral field, having a stronger intensity than the first and second fringe fields, is formed at the second display substrate due to first and second data voltages. As a result, the response speed of the liquid crystal is increased and the transmittance of the PVA mode liquid crystal display is enhanced and, since the first and second data voltages having different polarities are applied to the first and second pixel electrodes in one pixel region, the inversion of polarity is carried out in one pixel, thereby reducing the flicker phenomenon.

### BRIEF DESCRIPTION OF THE DRAWINGS

The above and other advantages of the present invention will become readily apparent by reference to the following detailed description when considered in conjunction with the accompanying drawings wherein:

FIG. 1 is a cross-sectional view showing a dual-field switching mode liquid crystal display according to an exemplary embodiment of the present invention;

FIG. 2 is a cross-sectional view showing a patternless dual-field switching mode liquid crystal display according to another exemplary embodiment of the present invention;

FIG. 3 is a cross-sectional view showing a patterned vertical alignment mode liquid crystal display according to another embodiment of the present invention;

FIG. 4 is a cross-sectional view showing a plane-to-line switching mode liquid crystal display according to another embodiment of the present invention;

FIG. 5 is a plan view showing a pixel applied to a second display substrate according to an exemplary embodiment of the present invention;

FIG. 6 is an equivalent circuit diagram of the pixel shown in FIG. 5;

FIG. 7 is a timing diagram of the pixel shown in FIG. 5;

FIG. 8 is a plan view showing a pixel applied to a second display substrate according to another exemplary embodiment of the present invention;

FIG. 9 is an equivalent circuit diagram of the pixel shown in FIG. 8;

FIG. 10 is a timing diagram of the pixel shown in FIG. 9;

FIG. 11 is a view showing an alignment of a liquid crystal in a conventional P-DFS mode liquid crystal display;

FIG. 12 is a graph showing a transmittance of the conventional P-DFS mode liquid crystal display shown in FIG. 11;

FIG. 13 is a view showing an alignment of a liquid crystal in a P-DFS mode liquid crystal display according to the present invention; and

FIG. 14 is a graph showing a transmittance of the P-DFS mode liquid crystal display shown in FIG. 13.

### DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items. Spatially relative terms, such as “beneath”, “below”, “lower”, “above”, “upper” and the like, may be used herein for ease of description to describe one element or feature's relationship to another element(s) or feature(s) as illustrated in the figures.

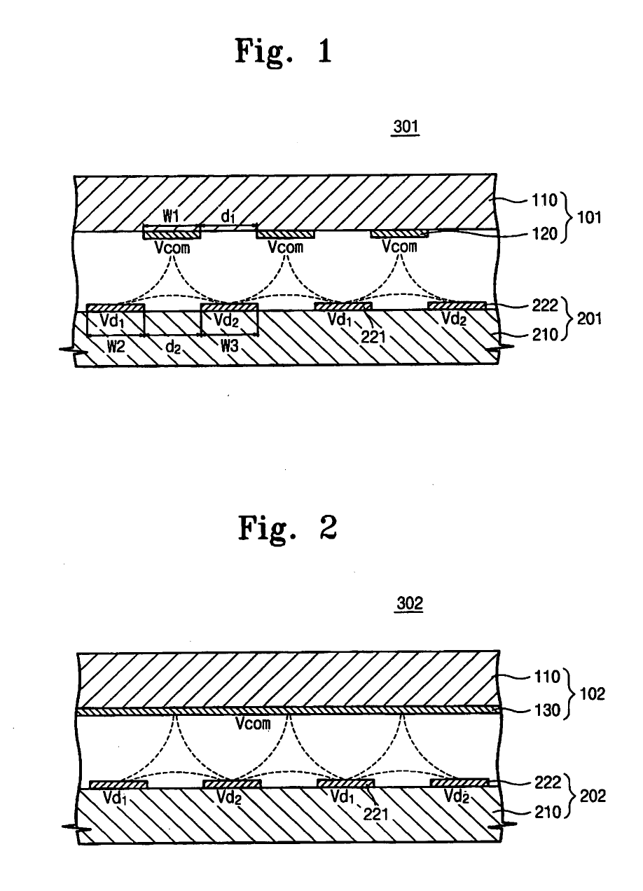

Referring to FIG. 1, a dual-field switching mode liquid crystal display 310 includes a first display substrate 101, a second display substrate 201 and a liquid crystal layer (not shown). The liquid crystal layer includes a plurality of liquid crystal molecules which is disposed between first substrate 101 and second substrate 201.

First display substrate 101 includes a first base substrate 110 and a common electrode 120 formed on the first base substrate 110. Common electrode 120 receives a common voltage Vcom. In the exemplary embodiment, common voltage Vcom may be about 7 volts. Common electrode 120 includes a plurality of sub common electrodes which are spaced apart from one another. Each of the sub common electrodes has a width W1 equal to or smaller than the distance between the sub common electrodes. Although not shown in FIG. 1, the first display substrate 101 may further include a black matrix and a color filter layer. Particularly, the black matrix and the color filter layer are interposed between the first base substrate 110 and common electrode 120.

Second display substrate 201 includes a second base substrate 210 and first and second pixel electrodes 221 and 222 formed on the second base substrate 210. The first pixel electrode 221 have a width W2 and the second pixel electrodes 222 have a width W3. The first and second pixel electrodes are adjacent to each other. Each of the widths W2 and W3 is equal to or smaller than the distance d2 between the first and second pixel electrodes 221 and 222. Also, common electrode 120 (on substrate 101) is formed at positions corresponding to positions between the first and second pixel electrodes 221 and 222 (on substrate 201). Thus, common electrode 120 is not overlapped by first and second pixel electrodes 221 and 222.

First pixel electrode 221 receives a first data voltage Vd1 which is higher than common voltage Vcom and second pixel electrode 222 receives a second data voltage Vd2 which is lower level than common voltage Vcom. In the exemplary embodiment, first and second data voltages Vd1 and Vd2 are about 14 volts and about 0 volts, respectively. That is, first data voltage Vd1 has a polarity opposite to that of the second data voltage Vd2 with reference to common voltage Vcom. The polarities of first and second data voltages Vd1 and Vd2 may be inverted in a column inversion method or a dot inversion method.

As shown in FIG. 1, a first fringe field caused by a rotation of the liquid crystal molecules in response to the voltage difference between first data voltage Vd1 and common voltage Vcom is formed between first pixel electrode 221 and common electrode 120. Similarly, a second fringe field caused by the rotation of the liquid crystal molecules in response to the voltage difference between the second data voltage Vd2 and common voltage Vcom is formed between the second pixel electrode 222 and common electrode 120. Further, a lateral field caused by the rotation of the liquid crystal molecules in response to the voltage difference between first and second data voltages Vd1 and Vd2 is formed between first and second pixel electrodes 221 and 222.

Thus, first and second fringe fields are formed between first and second display substrates 101 and 201. The lateral field having a stronger intensity than the first and second fringe fields is formed at the second display substrate 201 due to the first and second data voltages Vd1 and Vd2.

As a result, the response speed of the liquid crystal is increased and the transmittance of the DFS mode liquid crystal display 301 is enhanced since the fringe field is formed at the second display substrate 201.

Also, since first and second data voltages Vd1 and Vd2 having different polarities from each other are applied to first and second pixel electrodes 221 and 222, respectively, in one pixel, the inversion of polarity is carried out in one pixel, thereby reducing the flicker phenomenon.

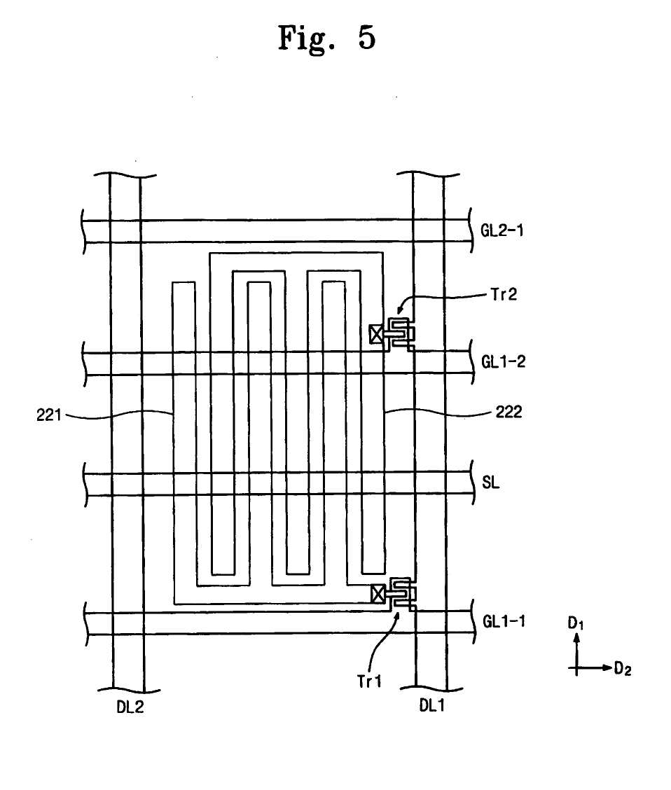

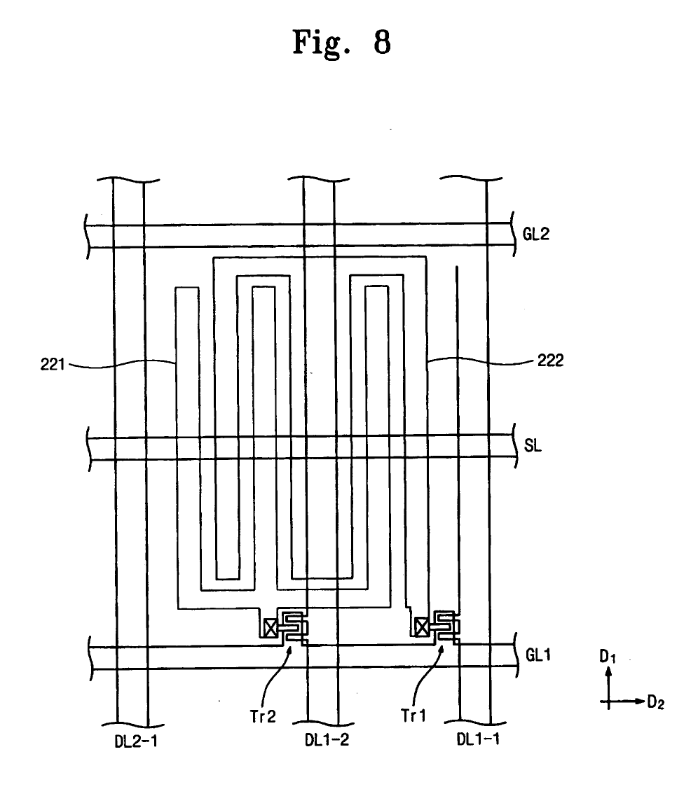

Although not shown in the drawing, first display substrate 101 further includes a first horizontal aligning film formed on common electrode 120, and the second display substrate 201 further includes a second horizontal aligning film formed on first and second pixel electrodes 221 and 222. Thus, the liquid crystal molecules are horizontally aligned during an initial state when a voltage is not applied to first pixel electrode 221, the second pixel electrode 222 and common electrode 120. The structure of the second display substrate 201 will be described with reference to FIGS. 5 and 8 in detail.

FIG. 2 is a cross-sectional view showing a patternless dual-field switching mode liquid crystal display according to another exemplary embodiment of the present invention. Referring to FIG. 2, in a P-DFS (patternless-dual field switching) mode liquid crystal display 302, a common electrode 130 is formed over first display substrate 102, but common electrode 130 is not divided into the sub common electrodes as shown in FIG. 1.

In this exemplary embodiment, a second display substrate 202 has same function and structure as those of the second display substrate 201 shown in FIG. 1, and thus descriptions of second display substrate 202 will be omitted. As shown in FIG. 2, common voltage Vcom is applied to common electrode 130, first data voltage Vd1 having a higher voltage level than that of common voltage Vcom is applied to first pixel electrode 221, and the second data voltage Vd2 having a lower voltage level than that of common voltage Vcom is applied to the second pixel electrode 222.

Thus, a first fringe field, caused by rotation of the liquid crystal molecules in response to the voltage difference between first data voltage Vd1 and common voltage Vcom, is formed between first pixel electrode 221 and common electrode 130. Also, a second fringe field, caused by rotation of the liquid crystal molecules in response to the voltage difference between the second data voltage Vd2 and common voltage Vcom, is formed between second pixel electrode 222 and common electrode 120. Further, a lateral field, caused by rotation of the liquid crystal molecules in response to the voltage difference between first and second data voltages Vd1 and Vd2, is formed between first and second pixel electrodes 221 and 222.

Thus, first and second fringe fields are formed between first and second display substrates 102 and 202, and the lateral field, having a stronger intensity than the first and second fringe fields, is formed at the second display substrate 202 due to first and second data voltages Vd1 and Vd2. As a result, the response speed of the liquid crystal is increased and the transmittance of the P-DFS mode liquid crystal display 302 is enhanced.

Also, since first and second data voltages Vd1 and Vd2 having the different polarity from each other are applied to first and second pixel electrodes 221 and 222, respectively, in one pixel region, the inversion of the polarity is carried out in one pixel, thereby reducing the flicker phenomenon.

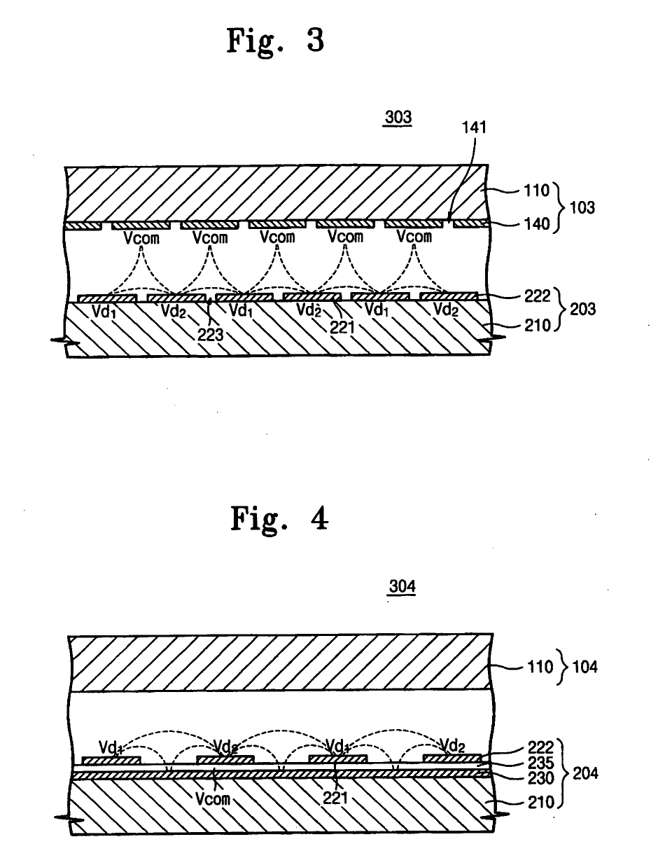

FIG. 3 is a cross-sectional view showing a patterned vertical alignment mode liquid crystal display according to another embodiment of the present invention. Referring to FIG. 3, a patterned vertical alignment (PVA) mode liquid crystal display includes a first display substrate 103 on which a common electrode 140 and a second display substrate 203 on which first and second pixel electrodes 221 and 222 are formed. Although not shown in figures, a liquid crystal layer having liquid crystal molecules is disposed between first and second display substrates 103 and 203.

Common electrode 140 includes a first opening 141 and first and second pixel electrodes 221 and 222 that are spaced apart from each other. In the present embodiment, a space between first and second pixel electrodes 221 and 222 is defmed as a second opening 223. First opening 141 is formed at a position corresponding to a space between two second openings 223. Thus, a plurality of domains may be formed in one pixel region due to first and second openings 141 and 223.

As shown in FIG. 3, common voltage Vcom is applied to common electrode 140, a first data voltage Vd1, having a higher voltage than common voltage Vcom, is applied to first pixel electrode 221, and a second data voltage Vd2, having a lower voltage level than that of common voltage Vcom, is applied to the second pixel electrode 222.

Thus, a first fringe field, caused by rotation of the liquid crystal molecules in response to the voltage difference between first data voltage Vd1 and common voltage Vcom, is formed between first pixel electrode 221 and common electrode 140. Also, a second fringe field, caused by rotation of the liquid crystal molecules in response to the voltage difference between second data voltage Vd2 and common voltage Vcom, is formed between second pixel electrode 222 and common electrode 120. Further, a lateral field, caused by rotation of the liquid crystal molecules in response to the voltage difference between first and second data voltages Vd1 and Vd2, is formed between first and second pixel electrodes 221 and 222.

As described above, the first and second fringe fields are formed between first and second display substrates 102 and 202. The lateral field, having a stronger intensity than the first and second fringe fields, is formed at the second display substrate 202 due to first and second data voltages Vd1 and Vd2.

As a result, the response speed of the liquid crystal is increased and the transmittance of the PVA mode liquid crystal display 303 is enhanced. Also, since first and second data voltages Vd1 and Vd2 having different polarities are applied to first and second pixel electrodes 221 and 222, respectively, in one pixel region, the inversion of polarity is carried out in one pixel, thereby reducing the flicker phenomenon.

Although not shown in FIG. 3, first display substrate 103 further includes a first vertical aligning film formed on common electrode 140, and the second display substrate 203 further includes a second vertical aligning film formed on first and second pixel electrodes 221 and 222. Thus, the liquid crystal molecules are vertically aligned during an initial state where a voltage is not applied to first pixel electrode 221, the second pixel electrode 222 and common electrode 140.

FIG. 4 is a cross-sectional view showing a plane-to-line switching mode liquid crystal display according to another embodiment of the present invention. Referring to FIG. 4, a plane-to-line switching (PLS) mode liquid crystal display 304 includes a first display substrate 104, a second display substrate 204 and a liquid crystal layer (not shown). First display substrate 104 includes a first base substrate 110. Although not shown in FIG. 4, first display substrate 104 may further include a black matrix and a color filter layer formed on first base substrate 110.

Second display substrate 204 includes a second base substrate 210, a common electrode 230, a first pixel electrode 221 and a second pixel electrode 222. Common electrode 230 is formed over the second base substrate 210, and an insulating interlayer 235 is formed on common electrode 230. First and second pixel electrodes 221 and 222 are formed on the insulating interlayer 235 and spaced apart from each other by a predetermined distance.

As shown in FIG. 4, common voltage Vcom is applied to common electrode 230, first data voltage Vd1 having the higher voltage level than that of common voltage Vcom is applied to first pixel electrode 221, and the second data voltage Vd2 having the lower voltage level than that of common voltage Vcom is applied to the second pixel electrode 222.

Thus, a first fringe field, caused by rotation of the liquid crystal molecules in response to the voltage difference between first data voltage Vd1 and common voltage Vcom, is formed between first pixel electrode 221 and common electrode 230. Also, a second fringe field, caused by the rotation of the liquid crystal molecules in response to the voltage difference between the second data voltage Vd2 and common voltage Vcom, is formed between the second pixel electrode 222 and common electrode 230. Further, a lateral field caused by the rotation of the liquid crystal molecules in response to the voltage difference between first and second data voltages Vd1 and Vd2 is formed between first and second pixel electrodes 221 and 222.

As described above, the first and second fringe fields are formed at the second display substrates 204, and the lateral field, having a stronger intensity than the first and second fringe fields, is formed at the second display substrate 204 due to first and second data voltages Vd1 and Vd2. As a result, the response speed of the liquid crystal is increased and the transmittance of the PLS mode liquid crystal display 304 is enhanced.

Also, since first and second data voltages Vd1 and Vd2 having different polarities from each other are applied to first and second pixel electrodes 221 and 222, respectively, in one pixel region, the inversion of polarity is carried out in one pixel, thereby reducing the flicker phenomenon.

FIG. 5 is a plan view showing a pixel applied to a second display substrate according to an exemplary embodiment of the present invention.

Referring to FIG. 5, a second display substrate 201 includes a data line DL1, a second data line DL2, a first gate line GL1-1, a second gate line GL1-2 and a third gate line GL2-1. First and second data lines DL1 and DL2 are extended in a first direction D1, and first, second and third gate lines GL1-1, GL1-2 and GL2-1 are extended in a second direction D2 substantially perpendicular to first direction D1. A rectangular-shaped pixel region is defined by first data line DL1, the second data line DL2, first gate line GL1-1 and the third gate line GL2-1 at the second display substrate 201. The second gate line GL1-2 is formed between first gate line GL1-1 and the third gate line GL2-1 to cross the pixel region.

In the pixel region of the second display substrate 201, a first thin film transistor Tr1, a second thin film transistor Tr2, a first pixel electrode 221 and a second pixel electrode 222 are formed. First thin film transistor Tr1 is electrically connected to first gate line GL1 and first data line DL1, and the second thin film transistor Tr2 is electrically connected to the second gate line GL1-2 and first data line DL1.

Particularly, first thin film transistor Tr1 includes a gate electrode branched from first gate line GL1-1, a source electrode branched from first data line DL1 and a drain electrode electrically connected to first pixel electrode 221. The second thin film transistor Tr2 includes a gate electrode branched from the second gate line GL1-2, a source electrode branched from first data line DL1 and a drain electrode electrically connected to the second pixel electrode 222.

First and second pixel electrodes 221 and 222 are spaced apart from each other and electrically insulated from one another. First and second pixel electrodes 221 and 222 are extended in first direction D1 and substantially parallel to first and second data lines DL1 and DL2. In the present embodiment, the second display substrate 201 is rubbed in the second direction D2, and the liquid crystal layer (not shown) interposed between first display substrate 101 (refer to FIG. 1) and the second display substrate 201 includes a negative type liquid crystal. However, when the second display substrate 201 is rubbed in first direction D1, the liquid crystal layer interposed between first and second display substrates 101 and 201 may include a positive type liquid crystal.

Although not shown in FIG. 5, first and second pixel electrodes 221 and 222 may be extended in the second direction D2 substantially parallel to first, second and third gate lines GL1-1, GL1-2 and GL2-1. Also, first and second pixel electrodes 221 and 222 may be extended in a third direction inclined with respect to first and second directions D1 and D2 by a predetermined angle. In the present embodiment, first and second pixel electrodes 221 and 222 may be inclined in a range from about 5 degrees to about 30 degrees with respect to first direction D1.

As shown in FIG. 5, the second display substrate 201 may further include a storage line SL extended in the second direction D2 substantially parallel to first gate line GL1-1. Storage line SL may include the same material as that of first gate line GL1-1 and is substantially simultaneously formed with first gate line GL1-1. Thus, storage line SL is formed on a different layer from the layer on which first and second pixel electrodes 221 and 222 are formed and is electrically insulated from first and second pixel electrodes 221 and 222.

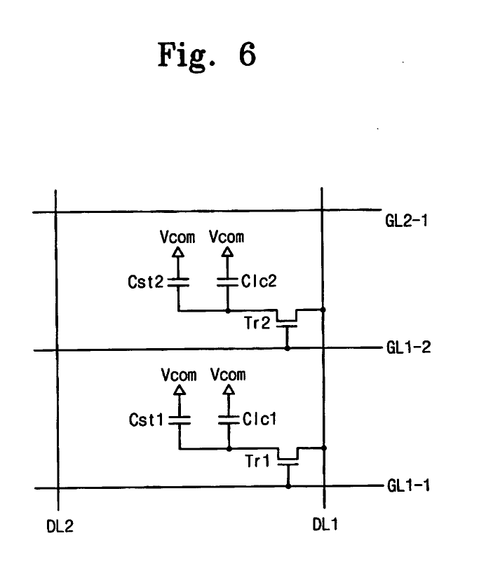

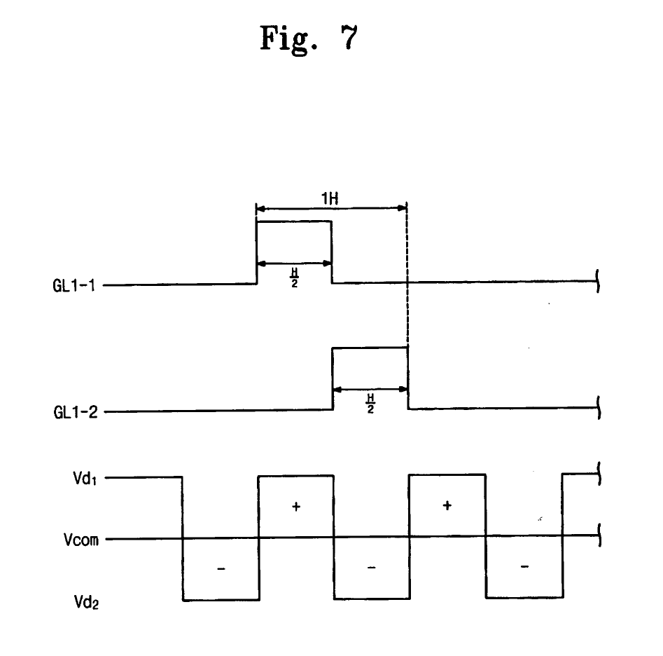

FIG. 6 is an equivalent circuit diagram of the pixel shown in FIG. 5, and FIG. 7 is a timing diagram of the pixel shown in FIG. 5. Referring to FIGS. 6 and 7, first thin film transistor Tr1 is electrically connected to first gate line GL1-1 and first data line DL1, and a first liquid crystal capacitor Clc1 and a first storage capacitor Cst1 are connected to the drain electrode of first thin film transistor Tr1 in parallel. First liquid crystal capacitor Clc1 includes a first electrode that is operated as first pixel electrode 221 (shown in FIG. 5), and a second electrode that is operated as common electrode 120 (shown in FIG. 1). Also, first storage capacitor Cst1 includes a first electrode that is operated as first pixel electrode 221 and a second electrode that is operated as the storage SL (shown in FIG. 5).

Second thin film transistor Tr2 is electrically connected to the second gate line GL1-2 and first data line DL1, and a second liquid crystal capacitor Clc2 and a second storage capacitor Cst2 are electrically connected to the drain electrode of the second thin film transistor Tr2. Second liquid crystal capacitor Clc2 includes a first electrode that is operated as second pixel electrode 222 (shown in FIG. 5) and a second electrode that is operated as common electrode 120. Second storage capacitor Cst2 includes a first electrode that is operated as the second pixel electrode 222 and a second electrode that is operated as the storage line SL.

When a time where one pixel is operated is defined as 1H time, first data voltage Vd1 having the higher voltage level than that of common voltage Vcom is applied to first data line DL1 during an earlier H/2 time of the 1H time and the second data voltage Vd2 having the lower voltage level than that of common voltage Vcom is applied to first data line DL1 during a later H/2 time of the 1H time. The first gate voltage is applied to first gate line GL1-1 during the earlier H/2 time, and the second gate voltage is applied to the second gate line GL1-2 during the later H/2 time.

First thin film transistor Tr1 provides first pixel electrode 221 with first data voltage Vd1 in response to the first gate voltage during the earlier H/2 time. Thus, a plus polarity voltage is charged into the first liquid crystal capacitor Clc1 due to the first data voltage Vd1 and common voltage Vcom.

During the later H/2 time, the second thin film transistor Tr2 provides the second pixel electrode 222 with the second data voltage Vd2 in response to the second gate voltage. Thus, a minus polarity voltage is charged into the second liquid crystal capacitor Clc2 due to the second data voltage Vd2 and common voltage Vcom.

That is, first and second data voltages Vd1 and Vd2 having the different polarity from each other are sequentially applied to first and second pixel electrode 221 and 222 during the earlier and later H/2 times, respectively. Thus, the inversion of the polarity may be carried out in one pixel, thereby reducing the flicker phenomenon.

FIG. 8 is a plan view showing a pixel applied to a second display substrate according to another exemplary embodiment of the present invention.

Referring to FIG. 8, a second display substrate 202 includes a first data line DL1-1, a second data line DL1-2, a third data line DL2-1, a first gate line GL1 and a second gate line GL2. First, second and third data lines DL1-1, DL1-2 and DL2-1 are extended in a first direction D1 and first and second gate lines GL1 and GL2 are extended in a second direction D2 substantially perpendicular to first direction D1. A rectangular-shaped pixel region is defined by the data lines DL1-1, DL1-2 and DL2-1 and the gate lines GL1 and GL2. The second data line DL1-2 is formed between first data line DL1-1 and the third data line DL2-1 to cross the pixel region.

The second display substrate 202 includes a first thin film transistor Tr1, a second thin film transistor Tr2, a first pixel electrode 221 and a second pixel electrode 222 formed in the pixel region. First thin film transistor Tr1 is electrically connected to first gate line GL1 and first data line DL1-1, and the second thin film transistor Tr2 is electrically connected to first gate line GL1 and the second data line DL1-2.

Particularly, first thin film transistor Tr1 includes a gate electrode branched from first gate line GL1, a source electrode branched from first data line DL1-1 and a drain electrode electrically connected to first pixel electrode 221. The second thin film transistor Tr2 includes a gate electrode branched from first gate line GL1, a source electrode branched from the second data line DL1-2 and a drain electrode electrically connected to the second pixel electrode 222.

First and second pixel electrode 221 and 222 are spaced apart from each other and electrically insulated from one another. First and second pixel electrodes 221 and 222 are extended in first direction D1 and substantially parallel to first, second and third data lines DL1-1, DL1-2 and DL2-1. In the present embodiment, the second display substrate 202 is rubbed in the second direction D2, and the liquid crystal layer (not shown) interposed between first display substrate 101 (shown in FIG. 1) and the second display substrate 202 includes a negative type liquid crystal. However, when the second display substrate 202 is rubbed in first direction D1, the liquid crystal layer interposed between first and second display substrates 101 and 202 may include a positive type liquid crystal.

Although not shown in FIG. 8, first and second pixel electrodes 221 and 222 may be extended in the second direction D2 substantially parallel to first and second gate lines GL1 and GL2. Also, first and second pixel electrodes 221 and 222 may be extended in a third direction inclined with respect to first and second directions D1 and D2 by a predetermined angle. In the present embodiment, first and second pixel electrodes 221 and 222 may be inclined in a range from about 5 degrees to about 30 degrees with respect to first direction D1.

As shown in FIG. 8, the second display substrate 202 may further include a storage line SL extended in the second direction D2 substantially parallel to first gate line GL1. The storage line SL may include a same material as that of first gate line GL1 and is substantially simultaneously formed with first gate line GL1. Thus, the storage line SL is formed on a different layer from a layer on which first and second pixel electrodes 221 and 222 and electrically insulated from first and second pixel electrodes 221 and 222.

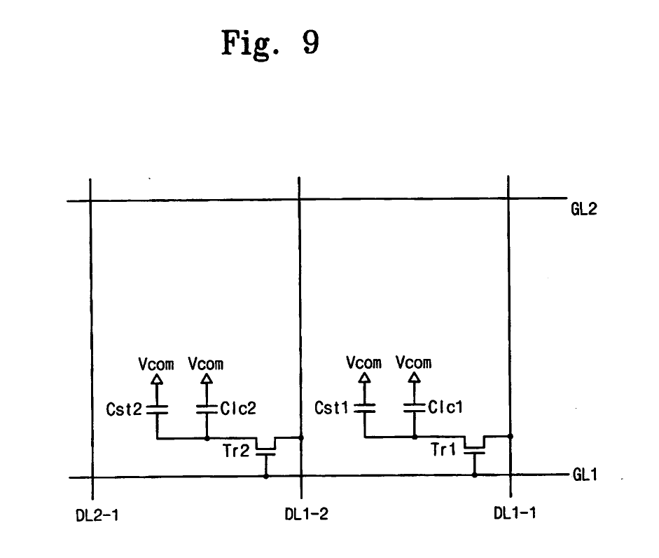

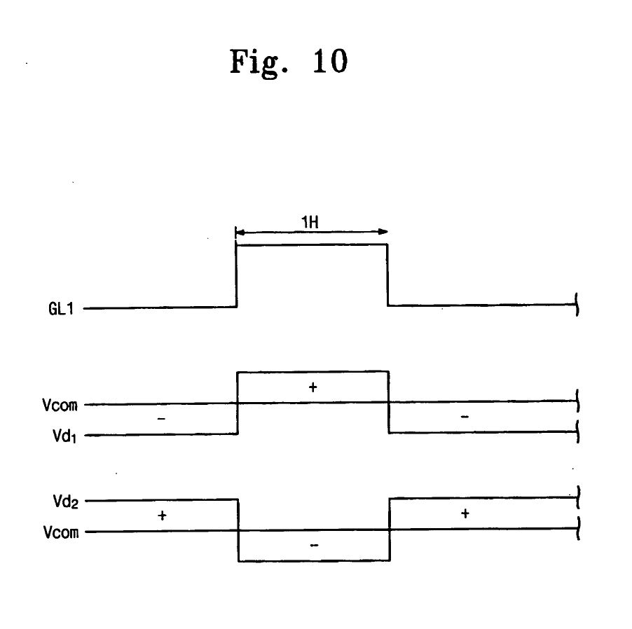

FIG. 9 is an equivalent circuit diagram of the pixel shown in FIG. 8, and FIG. 10 is a timing diagram of the pixel shown in FIG. 9.

Referring to FIGS. 9 and 10, first thin film transistor Tr1 is electrically connected to first gate line GL1 and first data line DL1-1, and first liquid crystal capacitor Clc1 and first storage capacitor Cst1 are electrically connected to the drain electrode of first thin film transistor Tr2 in parallel.

The second thin film transistor Tr2 is electrically connected to first gate line GL and the second data line DL1-2, and the second liquid crystal capacitor Clc2 and the second storage capacitor Cst2 are electrically connected to the drain electrode of the second thin film transistor Tr2 in parallel.

When a time where one pixel is operated is defined as 1H time, first data voltage Vd1 having the higher voltage level than that of common voltage Vcom is applied to first data line DL1-1 during the 1H time, and the second data voltage Vd2 having the lower voltage level than that of common voltage Vcom is applied to the second data line DL1-2 during the 1H time. The first gate voltage is applied to first gate line GL1 during the 1H time.

First thin film transistor Tr1 provides first pixel electrode 221 with first data voltage Vd1 in response to first gate voltage during the 1H time. Thus, a plus polarity voltage is charged into first liquid crystal capacitor Clc1 due to first data voltage Vd1 and common voltage Vcom.

During the 1H time, the second thin film transistor Tr2 provides the second pixel electrode 222 with the second data voltage Vd2 in response to the second gate voltage. Thus, a minus polarity voltage is charged into the second liquid crystal capacitor Clc2 due to the second data voltage Vd2 and common voltage Vcom.

That is, first and second data voltages Vd1 and Vd2 having the different polarity from each other are substantially simultaneously applied to first and second pixel electrode 221 and 222, respectively, during the 1H time. Thus, the inversion of the polarity may be carried out in one pixel, thereby reducing the flicker phenomenon.

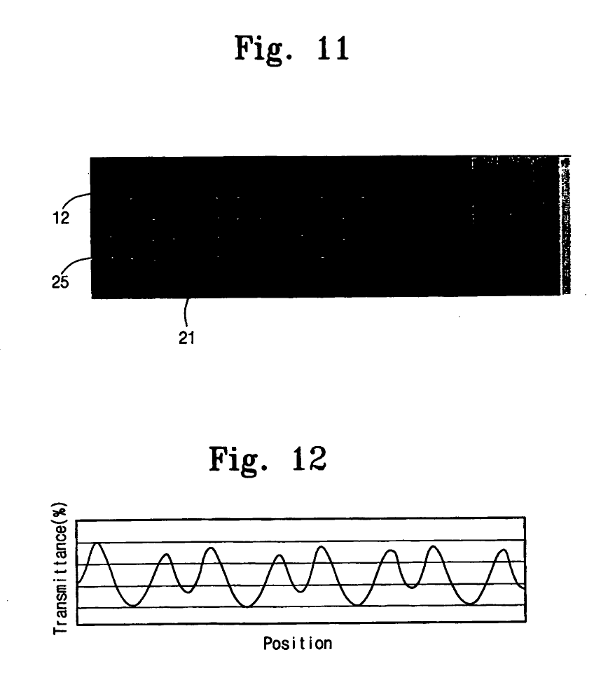

FIG. 11 is a view showing an alignment of a liquid crystal in a conventional P-DFS mode liquid crystal display. FIG. 12 is a graph showing a transmittance of the conventional P-DFS mode liquid crystal display shown in FIG. 11.

Referring to FIGS. 11 and 12, a common voltage of about 7 volts is applied to a common electrode 12 of a first display substrate, and a data voltage of about 13 volts is applied to a pixel electrode 21 of a second display substrate. Liquid crystal molecules 25 interposed between first and second substrates are aligned by a voltage difference between the common voltage and the data voltage. The transmittance of the P-DFS mode liquid crystal display has been measured at about 23.5 percents.

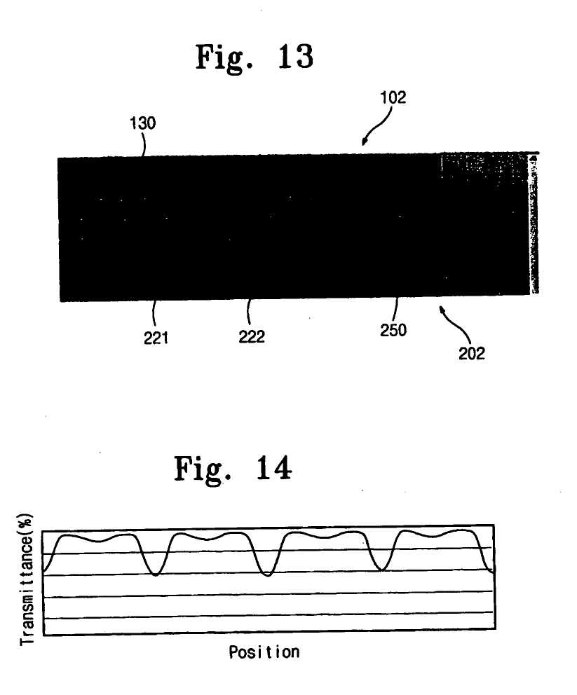

FIG. 13 is a view showing an alignment of a liquid crystal in a P-DFS mode liquid crystal display according to the present invention. FIG. 14 is a graph showing a transmittance of the P-DFS mode liquid crystal display shown in FIG. 13.

Referring to FIGS. 13 and 14, the common voltage of about 7 volts is applied to common voltage 130 of first display substrate 102, the first data voltage of about 14 volts is applied to first pixel electrode 221 of the second display substrate 202, and the second data voltage of about 0 volts is applied to the second pixel electrode 222 of the second display substrate 202. The liquid crystal molecules 250 interposed between first and second display substrates 102 and 202 are aligned due to the voltage difference between the common voltage and the first data voltage, the voltage difference between the common voltage and the second data voltage and the voltage difference between the first and second data voltages.

That is, the liquid crystal is rotated by the fringe field formed between the first and second display substrates and the fringe field formed in the second display substrate. Thus, the transmittance in the P-DFS mode liquid crystal display has been measured at about 45 percents improved by about 100% compared to the conventional P-DFS mode liquid crystal display as shown in FIG. 14.

According to the display apparatus, the first data voltage having the first polarity against to the common voltage is applied to the first pixel electrode, and the second data voltage having the second polarity with respect to the common voltage is applied to the second pixel electrode.

Thus, the fringe field is formed between the first and second display substrates and the lateral field is formed at the second display substrate, thereby improving the transmittance and the response speed of the display apparatus.

Further, the polarity of the voltage applied to the liquid crystal layer between the common electrode and the first pixel electrode is different from the polarity of the voltage applied to the liquid crystal layer between the common electrode and the second pixel electrode. Therefore, the inversion of the polarity may be carried out in one pixel, to thereby reduce the flicker phenomenon.

Although the exemplary embodiments of the present invention have been described, it is understood that various changes and modifications can be made by those skilled in the art without however departing from the spirit and scope of the present invention.

What is claimed is:

1. A display apparatus comprising:
a common electrode to which a common voltage is applied;
a first pixel electrode to which a first data voltage having a first polarity with reference to the common voltage is applied; and
a second pixel electrode to which a second data voltage having a second polarity different from the first polarity with reference to the common voltage is applied, the second pixel electrode being spaced apart from the first pixel electrode by a predetermined distance and electrically insulated from the first pixel electrode.

2. The display apparatus of claim 1, further comprising:
a first liquid crystal layer formed between the common electrode and the first pixel electrode; and
a second liquid crystal layer formed between the common electrode and the second pixel electrode.

3. The display apparatus of claim 2, wherein the first liquid crystal layer receives a voltage having a different polarity from that of a voltage applied to the second liquid crystal layer.

4. The display apparatus of claim 1, wherein the common electrode is formed at a position corresponding to a space between the first and second pixel electrodes spaced apart from each other by the predetermined distance.

5. The display apparatus of claim 4, wherein the common electrode has a width substantially equal to or smaller than the distance between the first and second pixel electrodes.

6. The display apparatus of claim 4, wherein the common electrode has a width greater than the distance between the first and second pixel electrodes, and an opening is formed at the position corresponding to the space between the first and second pixel electrodes, the opening being formed through the common electrode.

7. A display apparatus comprising:
a first display substrate including:
a first base substrate; and
a common electrode formed on the first base substrate to receive a common voltage,
a second display substrate including:
a second base substrate divided into a plurality of pixel regions;
a first pixel electrode formed in each of the pixel regions to receive a first data voltage having a first polarity with reference to the common voltage; and
a second pixel electrode formed in each of the pixel regions to receive a second data voltage having a second polarity different from the first polarity with reference to the common voltage, the second pixel electrode being spaced apart from the first pixel electrode by a predetermined distance and electrically insulated from the first pixel electrode.

8. The display apparatus of claim 7, wherein the common electrode is formed at a position corresponding to a space between the first and second pixel electrodes spaced apart from each other by the predetermined distance.

9. The display apparatus of claim 8, wherein the common electrode has a width substantially equal to or smaller than the distance between the first and second pixel electrodes.

10. The display apparatus of claim 8, wherein the common electrode has a width greater than the distance between the first and second pixel electrodes, and an opening is formed at the position corresponding to the space between the first and second pixel electrodes, the opening being formed through the common electrode.

11. The display apparatus of claim 7, wherein the second display substrate further comprises:
a first switching device electrically connected to the first pixel electrode to apply the first data voltage to the first pixel electrode; and
a second switching device electrically connected to the second pixel electrode to apply the second data voltage to the second pixel electrode.

12. The display apparatus of claim 11, wherein the second display substrate further comprises:
a first gate line to receive a first gate voltage for an earlier H/2 time of an 1H time where a pixel is operated, the first gate line being electrically connected to a gate electrode of the first switching device;
a second gate line to receive a second gate voltage for a later H/2 time of the 1H time, the second gate line being electrically connected to a gate electrode of the second switching device; and
a data line to receive the first data voltage for the earlier H/2 time and the second data voltage for the later H/2 time, the data line being electrically connected to a source electrode of the first switching device and a source electrode of the second switching device.

13. The display apparatus of claim 12, wherein the first switching device applies the first data voltage to the first pixel electrode in response to the first gate voltage during the earlier H/2 time, and the second switching device applies the second data voltage to the second pixel electrode in response to the second gate voltage during the later H/2 time.

14. The display apparatus of claim 12, wherein the first and second pixel electrodes are extended in a direction substantially parallel to the data line.

15. The display apparatus of claim 11, wherein the second display substrate further comprises:
a gate line electrically connected to a gate electrode of the first switching device and a gate electrode of the second switching device to receive a gate voltage;
a first data line electrically connected to a source electrode of the first switching device to receive the first data voltage during an 1H time where a pixel is operated; and
a second data line electrically connected to a source electrode of the second switching device to receive the second data voltage during the 1H time.

16. The display apparatus of claim 15, wherein the first switching device applies the first data voltage to the first pixel electrode in response to the gate voltage during the 1H time, and the second switching device applies the second data voltage to the second pixel electrode in response to the gate voltage during the 1H/2 time.

17. The display apparatus of claim 15, wherein the first and second pixel electrodes are extended in a direction substantially parallel to the first and second data lines.

18. The display apparatus of claim 7, wherein the second display substrate further comprises a storage line insulated from and facing the first and second pixel electrodes to receive the common voltage.

19. The display apparatus of claim 7, further comprising a liquid crystal layer having a plurality of liquid crystal molecule and disposed between the first and second display substrates.

20. The display apparatus of claim 19, wherein the liquid crystal molecules are a negative type and the second display substrate is rubbed in a direction substantially perpendicular to an extended direction of the first and second pixel electrodes.

21. The display apparatus of claim 19, wherein the liquid crystal molecules are a positive type and the second display substrate is rubbed in a direction substantially parallel to an extended direction of the first and second pixel electrodes.

22. A display apparatus comprising:
a first display substrate including a first base substrate; and
a second display substrate including:
a second base substrate;
a common electrode formed on the second base substrate to receive a common voltage;
a first pixel electrode electrically insulated from the common electrode to receive a first data voltage having a higher voltage level than that of the common voltage; and
a second pixel electrode electrically connected to the common electrode and the first pixel electrode to receive a second data voltage having a lower voltage level than that of the common voltage.

23. The display apparatus of claim 22, further comprising an insulating interlayer is formed between the common electrode and the first pixel electrode and between the common electrode and the second pixel electrode.

24. The display apparatus of claim 22, wherein the second display substrate further comprises:
a first switching device electrically connected to the first pixel electrode to apply the first data voltage to the first pixel electrode; and
a second switching device electrically connected to the second pixel electrode to apply the second data voltage to the second pixel electrode.

25. The display apparatus of claim 22, further comprising a liquid crystal layer having a plurality of liquid crystal molecule and disposed between the first and second display substrates.
